(19) United States
(12) Patent Application Publication
(10) Pub. No.: US 2026/0192255 A1
(43) Pub. Date: Jul. 9, 2026

(54) HYBRID PROCESS AND SYSTEM FOR RECOVERING WATER

(71) Applicant: SUNVAPOR, INC., Pasadena, CA (US)

(72) Inventors: Brandon Hathaway, Pasadena, CA (US); Philip Gleckman, Pasadena, CA (US)

(21) Appl. No.: 19/553,046

(22) Filed: Feb. 27, 2026

Related U.S. Application Data
(63) Continuation-in-part of application No. 18/015,942, filed on Jul. 14, 2021, now Pat. No. 12,565,436.
(60) Provisional application No. 63/051,886, filed on Jul. 14, 2020.
(60) Provisional application No. 63/888,658, filed on Sep. 26, 2025.

(51) Int. Cl. B01D 61/36; B01D 1/06; B01D 1/28; B01D 3/00; B01D 61/02; B01D 61/58; C02F 1/08; C02F 1/44; C02F 9/00; C02F 103/08

(52) U.S. Cl. CPC B01D 61/368; B01D 1/065; B01D 1/28; B01D 3/007; B01D 61/364; B01D 61/366; B01D 61/58; C02F 1/08; C02F 1/447; C02F 9/00; B01D 61/025; B01D 2311/08; B01D 2313/221; C02F 1/441; C02F 2103/08; C02F 2303/10

(57) ABSTRACT

A hybrid process and system for separating water from an inlet brine solution is disclosed. The hybrid process couples at least two different separation processes/systems. The inlet brine solution is fed into a first separation process, which produces a water distillate and a brine concentrate. The brine concentrate from the first separation process is then fed into the second separation process to further recover additional water. The excess heat from the second separation process is supplied to the first separation process.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is related to a process for recovering water from brine, and a system for performing such a process.

### Description of the Related Art

Brackish water is an enormous untapped resource for semiarid states in critical need of low-salinity water. Reverse Osmosis (RO) is an energy efficient technology that can recover about 50% of the water but produces brine waste as a by-product. Brine discharge to surface waters has a detrimental impact on the environment and is regulated. The use of evaporation ponds is limited by the high cost of land required and the potential for environmental damage due to leakage that increases with the quantity of disposed brine. Therefore, government agencies such as the U.S. Bureau of Reclamation have sought methods from industry to significantly reduce the volume of brine waste to bring the footprint of evaporation ponds to levels that are economically and environmentally acceptable. The conventional method of high-water recovery is based on mechanical vapor compression (MVR). MVR has been deployed to treat wastewater from power plants that must comply with environmental regulations. However, MVR has serious drawbacks: (1) high electricity consumption, (2) high capital costs, and (3) it relies on baseload electricity generated from fossil fuel. A renewable energy-based process that is otherwise similar is use of solar steam to drive only thermal vapor recompression (TVR), however it suffers from (1) high thermal energy consumption and (2) high capital costs.

### SUMMARY

Provided herein includes a system for concentrating a solution, comprising a first separation module configured to separate water from an inlet solution stream to form a first concentrated solution and a first water stream; a second separation module configured to further separate water from the first concentrated solution to form a second concentrated solution and a second water stream; wherein a high temperature steam provides heat to the second separation module; a heating module comprising a first heating unit configured to utilize excess heat from the second separation module to heat the inlet solution before entering the first separation module for water separation; and a liquid conduit connecting the first separation module and the second separation module and is configured to deliver at least a portion of the first concentrated solution to the second separation module.

In some embodiments, the first separation module comprises one or more of a membrane distillation module, a forward osmosis desalination module, an enhanced-multi effect thermal separation module, and a humidification-dehumidification module. In some embodiments, the second separation module comprises an evaporator. In some embodiments, the second separation module further comprises a thermocompressor configured to recycle a reduced-temperature vapor exiting the evaporator, wherein the thermocompressor is driven by the high temperature steam.

In some embodiments, the first heating unit is a condenser. In some embodiments, the heating module further comprises a second heating unit downstream of the first heating unit, wherein the second heating unit is configured to utilize a portion of the high temperature steam to further heat the inlet solution. In some embodiments, the second heating unit is an absorption heat pump.

In other embodiments, first heating unit comprises an absorption heat pump. In some embodiments, the system further comprises a high temperature heat pump configured to heat an excess vapor stream from the second separation module prior to being used by the absorption heat pump to heat the inlet solution.

In some embodiments, the system can handle an inlet solution comprising a brine having a concentration of about 10,000 ppm TDS and higher. In some embodiments, the system further comprises an upstream reverse osmosis module that produces the inlet solution.

Also provided herein includes a process for concentrating an inlet solution, comprising heating an inlet solution to form a heated inlet solution; feeding the heated inlet solution into a first separation process thereby producing a first concentrated solution and a first water stream; feeding the first concentrated solution into a second separation process thereby producing a second concentrated solution and a second water stream; and wherein the second separation process is configured to use a high temperature steam as an energy source, and an excess heat from the second separation process is delivered to the first separation process for heating the inlet solution.

In some embodiments, the step of heating the inlet solution comprises feeding the inlet solution through a condenser heated by the excess heat. In some embodiments, heating the inlet solution further comprises feeding the inlet solution through an absorption heat pump after feeding through the condenser, wherein the absorption heat pump receives heat from a portion of the high temperature steam.

In some embodiments, the step of heating the inlet solution comprises feeding the inlet solution through an absorption heat pump configured to receive heat from the excess heat. In some embodiments, the excess heat comprises upgraded excess vapor stream produced by feeding an excess vapor stream from the second separation process through a high temperature heat pump.

In some embodiments, the first separation process comprises membrane distillation.

In some embodiments, the second separation process comprises evaporation.

In some embodiments, the high temperature steam is used as a motive steam to drive a thermocompressor to recover the reduced-temperature vapor from the evaporator.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a process flow diagram of a process/system for recovering water from brine solution.

FIG. 2 is a process flow diagram of another process/system for recovering water from brine solution.

FIG. 3 is a process flow diagram of an embodiment of the process/system represented in FIG. 1.

FIG. 4 is a process flow diagram of another embodiment of the process/system represented in FIG. 1.

FIG. 5 is a process flow diagram of an embodiment of the process/system represented in FIG. 2.

FIG. 6 is an example of a hybrid process/system.

FIG. 7 is a is a process flow diagram of a process/system for recovering water from brine solution.

FIG. 8 is a process flow diagram of another process/system for recovering water from brine solution.

FIG. 9 is a process flow diagram of an embodiment of the process/system represented in FIG. 7.

FIG. 10 is a process flow diagram of an embodiment of the process/system represented in FIG. 8.

### DETAILED DESCRIPTION OF THE EMBODIMENTS

The disclosed technology relates to a system and process for recovering water from brine solution, and further reducing the volume of discharged brine. The efficient use of the heat removed from the processes also further reduces the thermal energy consumption for an industrial desalination process. The disclosed process overcomes the disadvantages of conventional high recovery processes like MVR as well as those of non-hybridized renewable processes like TVR.

Provided herein are systems and processes for recovering water and concentrating an inlet brine, including brackish water, sea water, or brine produced from a variety of sources such as reverse osmosis waste, cooling tower blowdown, or brine reservoirs for carbon sequestration with a feedwater total dissolved solids (TDS) of >3%. The hybrid system comprises a high temperature separation system coupled to a low temperature separation system, wherein the heat removed from the high temperature system is sent to the low temperature separation system as a low-grade heat source, and the withdrawn brine concentrate from the low temperature system is sent to the high temperature separation system for further removal of water. As a result, further concentration of the brine solution occurs in the high temperature separation system, which further reduces the volume of the brine discharge. As a hybrid system/process, the high temperature separation system and the low temperature separation system may not be the same. For example, the two separation systems involve different types of separation processes for removing water from the brine solution.

In some embodiments, the low-grade heat produced from the high temperature separation system is used to heat the circulating brine solution in the low temperature separation system. In other embodiments, the low-grade heat from the high temperature separation system is used to heat the circulating draw solution to recover water.

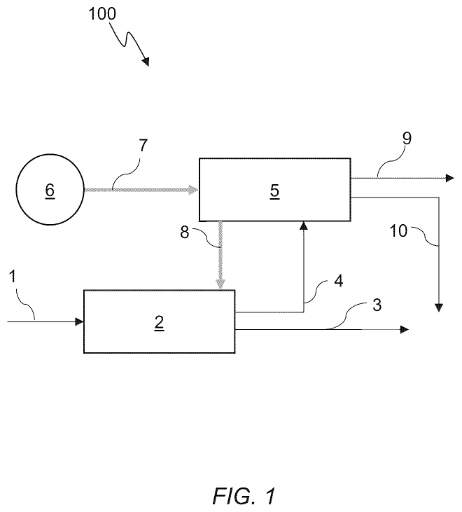

With reference to FIG. 1, a hybrid process 100 for separating water from an inlet brine solution includes feeding the inlet brine solution 1 into a first separation process 2 thereby producing a first water distillate 3 and a first concentrated brine solution 4; feeding the first concentrated brine 4 solution into a second separation process 5 thereby producing a second water distillate 10 and a second concentrated brine solution 9; and wherein the first separation process occurs at a lower temperature than the second separation process; and heat removed 8 from the second separation process is provided to the first separation process 2.

In some embodiments, the first separation process 2 is a low temperature process with a top brine temperature in the range of between about 40° C. and about 86° C., between about 40° C. and about 75° C., or between about 60° C. and about 86° C. In some embodiments, the second separation process 5 is a high temperature process with a top brine temperature in the range of between about 86° C. and about 110° C., between about 86° C. and about 95° C., and between about 90° C. and about 110° C. A high temperature heat 7 is provided to the second separation process 5, while a low temperature heat 8 is provided to the first separation process 2. In some embodiments, the hybrid process 100 further comprising a thermal energy source 6 that provides a high temperature heat 7 to the second separation process 5.

In some embodiments, the hybrid process 100 further include a thermal energy source 6 that provides a high temperature heat 7 for the second separation process 5. Some non-limiting examples of the thermal energy source 6 include solar thermal energy, geothermal energy, nuclear energy, or exothermic chemical reaction. Preferably, the thermal energy source 6 is a renewable energy source. In some embodiments, the thermal energy source 6 is solar thermal energy. A relatively high capacity factor (>30%) source of low-cost renewable steam can be used to evaporate water from the brine. In some embodiments, the steam discharged from a steam accumulator that has stored thermal energy collected from a field of solar collectors may be a source. The steam, which is saturated and at a pressure in the range about 30 to about 150 psig, and preferentially at a pressure of 100 psig, supplies the motive steam in a second separation process for a thermocompressor that takes the place of the mechanical compressor used in MVR. In each case, compression recycles the latent heat of vapors produced, for example, in the falling film evaporator, thereby increasing the gained output ratio (GOR, i.e., mass of distillate per mass of steam consumed).

In some embodiments, the hybrid process 100 further comprising collecting the first water distillate and the second water distillate. For example, the water distillate may be delivered to a distillate tank 11. The water distillate in the distillate tank 11 may be withdrawn for use as needed. In some embodiments, the water distillate may be used as the liquid feed water for steam generation or for use within the steam cycle for heating purposes.

The hybrid process 100 involves two different types of separation processes to efficiently achieve the removal of water from a brine stream. In some embodiments, the second concentrated brine solution has a higher concentration than the first concentrated brine solution, and the first concentrated brine solution has a higher concentration than the inlet brine solution. In some embodiments, the second concentrated brine solution 9 may be a saturated brine solution, for example, about 25% to about 30% total dissolved solid by weight. In some embodiments, the saturated brine solution is disposed in an evaporation pond. In some embodiments, the second concentrated brine solution 9 may not be a saturated brine solution. In some embodiments, the second concentrated brine solution 9, whether saturated or not, can be fed into a third separation system/process for further reducing the volume of the brine waste and recovering additional water. In some embodiments, zero liquid discharge or minimum liquid discharge may be achieved by adding the third separation process to the system.

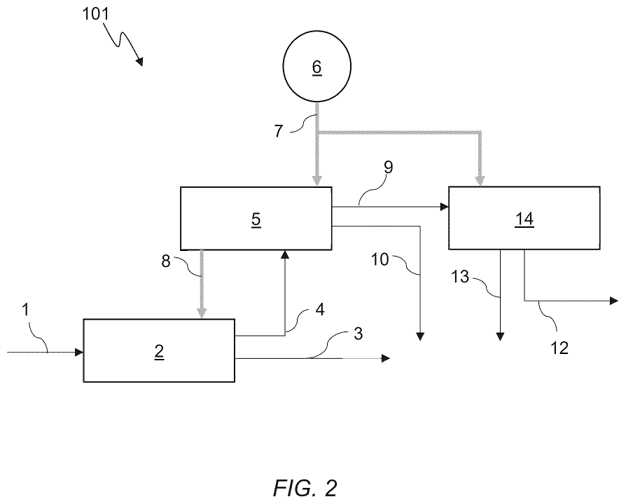

In some embodiments, a third separation process 14 may be coupled to the second separation process 5 as depicted in the process diagram of FIG. 2. A hybrid process 101 for separating water from an inlet brine solution includes (1) feeding the inlet brine solution 1 into a first separation process 2 thereby producing a first water distillate 3 and a first concentrated brine solution 4, (2) feeding the first concentrated brine 4 solution into a second separation process 5 thereby producing a second water distillate 10 and a second concentrated brine solution 9, and (3) feeding the second concentrated brine solution 9 into a third separation process 14 thereby producing a third water distillate 13 and a filtrate waste 12. The first separation process 2 occurs at a lower temperature than the second separation process 5; and heat removed from the second separation process 5 is provided to the first separation process 2. In some embodiment, a portion of the vapor liberated from the brine solution (i.e., heat) in the third separation process 14 may also be delivered to the first separation process 2 for heating purposes.

The third separation process may be a high temperature process with a top brine temperature in the range of between about 86° C. and about 110° C., between about 86° C. and about 95° C., and between about 90° C. and about 110° C. In some embodiments, the third separation process 14 can occur at the same temperature as the temperature of the second separation process 5. In other embodiments, the third separation process 14 can occur at a different temperature as the temperature of the second separation process 5.

The filtrate waste 12 may comprise solids, a slurry, saturated solution (e.g., a saturated brine solution), or a combination thereof. In some embodiments, the solid in the filtrate waste 12 may comprise salt crystals.

In some embodiments, the first separation process 2 may involve membrane distillation, forward osmosis desalination, enhanced-multi effect thermal separation, or humidification-dehumidification. In some embodiments, the second separation process 5 may involve vertical falling film evaporation, forced circulation crystallization, multiple effect distillation, or multistage flash.

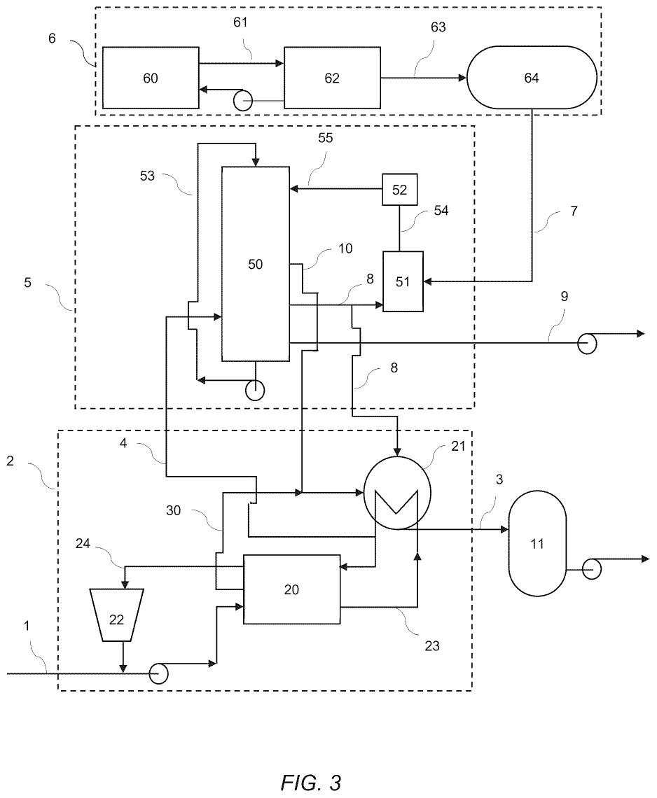

In some embodiments, the hybrid process 100 or 101 may involve the membrane distillation as the first separation process 2 and the vertical falling film evaporation as the second separation process 5. Example process flow diagrams of various embodiments are shown in FIGS. 3 to 5. In some embodiments, feeding the inlet brine solution 1 into a first separation process 2 involves feeding the inlet brine solution 1 into a first circulating brine stream 23, heating the first circulation brine stream 23 using the heat removed 8 from the second separation process 5 (i.e., low temperature heat), and passing the first circulating brine stream 23, now heated, through the hot side of the membrane distillation module 20 after the heating step. The water in the first circulating brine solution 23 would be recovered as a permeate 30, and the remaining brine stream 30 is mixed with the inlet brine solution 1 and continue to circulate in the system.

The circulating brine stream 23 may be heated by passing through a condenser 7 with the heat removed 8 from the second separation process 5. The heat removed 8 from the second separation process 5 may be delivered to the condenser 7 as water vapor. In some embodiments, other heat exchanging liquid or means may be used to deliver the heat removed 8 from the second separation process 5 to the first separation process 2. In some embodiments, the permeate 30 (i.e., water vapor) from the membrane distillation module 20 may be delivered to the condenser 7 for additional heat. In some embodiments, water is condensed from the vapor delivered to the condenser 7 and recovered as the first water distillate 3. In some embodiments, a portion of the circulating brine stream 23 may be withdrawn as the first concentrated brine solution 4, for delivering to the second separation process 5.

In some embodiments, the first circulating brine stream 23 also passes through the cool side of the membrane distillation module 20 as shown in FIG. 3. In some embodiments, a cooling process 22 is employed to cool the remaining brine stream 30 that comes out of the hot side 24 before the inlet brine solution 1 is fed into the first circulating brine stream 23. The cooled circulating brine stream then passes through the cold side.

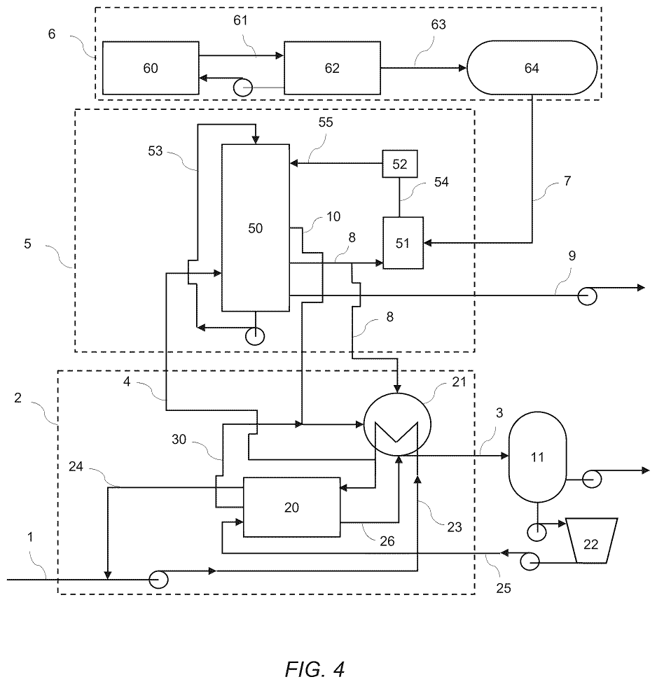

In some embodiments, the first circulating brine stream 23 does not pass through the cold side of the membrane distillation module 20. Instead, the water distillate in the distillate tank 11 is withdrawn for circulating through the cold side of the membrane distillation module 20 as shown in FIG. 4. In some embodiments, a cooling process 22 is employed to cool the water distillate prior to passing through the cold side of the membrane distillation module 20. The water distillate warms up as it passes through the membrane distillation module 20, and is directed to the condenser 7 before returning to the distillate tank 11.

In some embodiments, feeding the first concentrated brine solution 4 into the second separation process includes feeding the first concentrated brine solution into a second circulating brine stream, and heating the second circulation brine stream 53. A portion of the first circulating brine stream 23 is delivered to the vertical falling film evaporator 50 as the first concentrated brine solution 4. The first concentrated brine solution 4 is mixed in with the second circulating brine stream 53 and heated in the evaporator 60. Water is liberated from the second circulating brine stream 53 forming water vapor 8, while a second concentrated brine solution 9 is withdrawn from the evaporator module 50. The high temperature heat 7 is the prime energy input to the second separation process 5. The saturated steam 55 enters the evaporator 50 where it condenses on the exterior of the vertical tubes providing heat for the liberation of water vapor 8 from the circulating brine stream 53.

In some embodiments, the hybrid process 100 or 101 may involve the forward osmosis desalination as the first separation process 2 and the vertical falling film evaporation as the second separation process 5. The inlet brine solution 1 passes through the forward osmosis module on one side of the water-permeable membrane, while a draw solution passes through the other side of the membrane. The water in the inlet brine solution 1 is drawn across the membrane into the draw solution. The diluted draw solution exits the forward osmosis module and enters a draw solution recovery module. The low temperature heat 8 is used for providing heat to liberate water from the diluted draw solution, thereby recovering the draw solution for further circulation. The vertical falling film evaporation process is as described above.

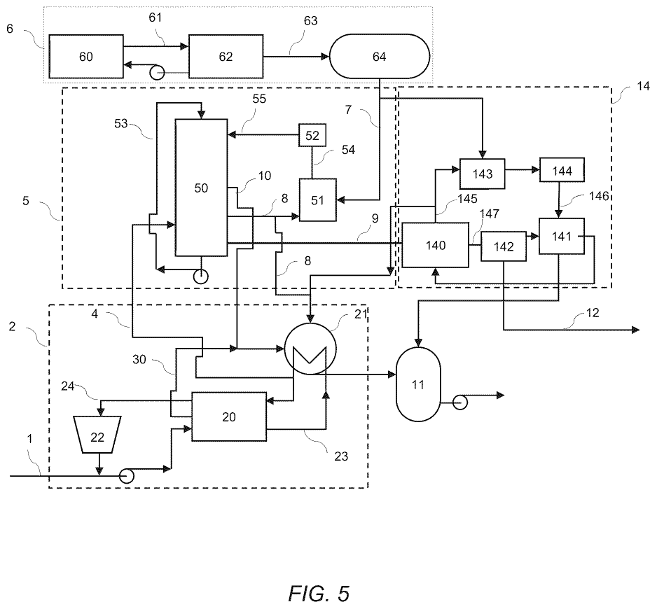

In some embodiments, the third separation process 14 may involve forced convection crystallization as shown in FIG. 5. The second concentrated brine solution 9 that is fed into the third separation process 14 may or may not be a saturated brine solution. In some embodiments, the second concentrated brine solution 9 has a total dissolved solid concentration of about 10% to about 20% by weight.

In some embodiments, the second concentrated brine solution 9 is fed into the forced convection crystallizer module 140, wherein the water in the second concentrated brine solution 9 is liberated forming a vapor stream 145, any crystallized solids are removed from the brine stream 147 as it passes through the filtration process 142 on its way to the condensing heat exchanger 141 before returning to the forced convection crystallizer module 140. The vapor stream 145 is brought into a saturated steam and provides heat needed for liberation of vapor within the crystallizer module 140. In some embodiments, a portion of the vapor stream 145 may be delivered to the first separation process to provide additional low temperature heat.

The disclosure also provides a hybrid system for separating water from an inlet brine solution. The system includes a first separation system with an intake for receiving inlet brine solution, a low temperature heat intake, a first concentrated brine solution outlet, and a water distillate discharge outlet, a second separation system with a first concentrated brine solution inlet, a second concentrated brine solution outlet, an excess heat outlet, a water distillate outlet. The first concentrated brine solution outlet is in fluid communication with the first concentrated brine intake. The excess heat outlet is in fluid communication with the low temperature heat intake. The first separation system and the second separation system are different. In some embodiments, the hybrid system further included a third separation system with a high temperature heat intake, a filtrate waste outlet, and a third water distillate outlet. The detail parts of the system are apparent from the description of the hybrid process and the process flow diagrams.

The falling film evaporator alone does not achieve a sufficiently energy-efficient pathway to high brine volume reductions. The disclosed hybrid process/system is capable of achieving a significantly higher (~2.5×) efficiency for the same 10× brine volume reduction.

The systems and processes described herein involve directing excess heat from the second separation process (e.g., a high temperature process) for use in the first separation process (e.g., low temperature process). In some embodiments, the excess heat from the second separation process is directed to heat the brine solution prior to going through the first separation process. In some embodiments, additional heat may be provided to heat the incoming brine solution in the first separation process to a higher temperature and allow for recovering more water in the first separation process. In some embodiments, additional heat provided to heat the incoming brine also allows more efficient recovery of water from a lower concentration brine as an inlet feed, such as feed concentration as low as 10,000 ppm TDS. In certain embodiments, provided herein is a process for separating water from an inlet brine solution comprising a first stage process, and a second stage process. The first stage process includes a first separation process driven by heat provided from the second separation process. The second stage process includes a second separation process that is driven by a motive steam/high temperature steam. In some embodiments, the motive steam may be generated using renewable energy, such as solar energy. In some embodiments, the motive steam may be a solar steam. In some embodiments, the solar steam may have a temperature of at least about 160° C., at least about 170° C., or at least about 180° C. The heat from the second separation process may include reduced-temperature vapor from the evaporation process (e.g., vapor generated from the separation process). In some embodiments, the reduced-temperature vapor may be directed to heat the inlet brine in the first separation process. In some embodiments, the reduced-temperature vapor may be compressed by the thermocompressor (i.e., thermal vapor compressor) which results in a higher temperature vapor (i.e., hot vapor). In some embodiments, this higher temperature vapor/hot vapor can also be further heated by a high temperature heat pump and provided to heat the inlet brine in the first separation process.

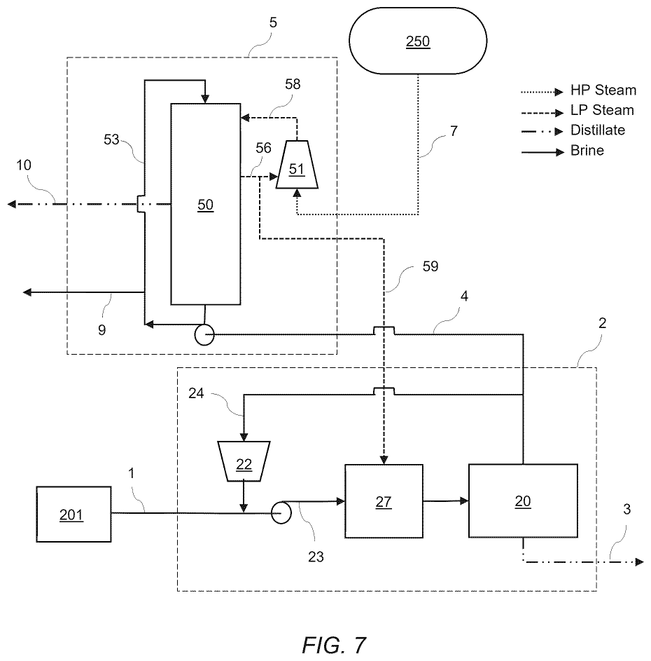

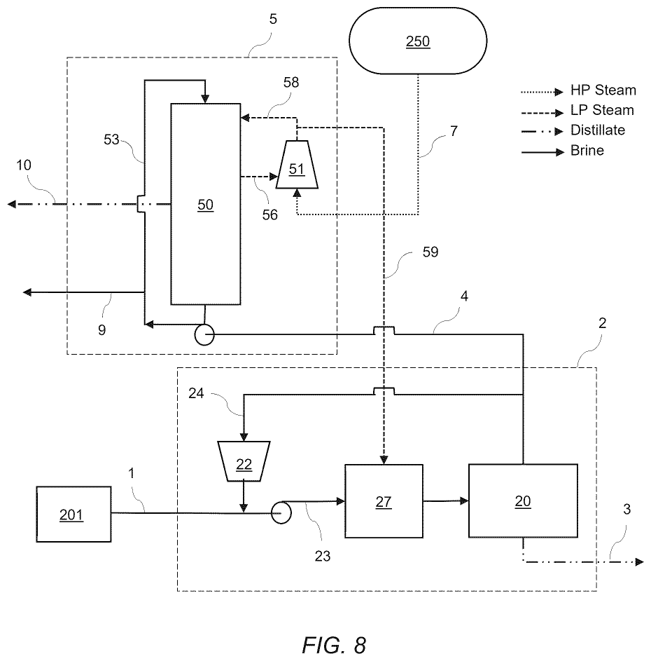

As shown in FIGS. 7 and 8, the first separation process 2 includes feeding an inlet brine solution 1 through a heating module 27 to a first separation module 20, thereby separating water from the entering brine stream to form a first water distillate 3 and a first concentrated brine solution 4. The first concentrated brine solution 4 is delivered to the second separation process 5. In some embodiments, a portion of the first concentrated brine solution 4, which portion is rejected brine 24, is circulated back to be mixed into the inlet brine solution 1 to form a first circulating brine stream 23. The circulating brine stream 23 is heated by the heating module 27 and fed into the first separation module 20 undergoing water separation. The heating module 27 is configured to use the excess heat (e.g., excess vapor stream 59) from the second separation process 5 to heat the first circulating brine 23/inlet brine solution 1.

The second separation process 5 includes feeding the first concentrated brine solution 4 into the second separation module 50, thereby forming a second water distillate 10 and a second concentrated brine solution 9. The second separation module 50 is heated by a hot vapor 58 entering the second separation module 50. The hot vapor cools as the heat exchange occurs within the second separation module 50, generating vapor from the first concentrated brine solution, thereby further concentrating the first concentrated brine solution to form the second concentrated brine solution. A portion of the vapor generated from the second separation process exits the second separation module 50 as reduced-temperature vapor 56.

A portion of the reduced-temperature vapor 56 from the second separation module 50 (e.g., excess heat) is delivered to the heating module 27 in the first separation process 2. In some embodiments, the excess heat (in the form of excess vapor stream 59) may include a portion of the reduced-temperature vapor 56 (as depicted in FIG. 7). In other embodiments as shown in FIG. 8, the excess heat (i.e., excess vapor stream 59) may include a portion of the hot vapor 58 (after going through the thermocompressor 51), thus delivering a higher temperature vapor to the heating module 27. In some embodiments, additional heating may be added to further increase the temperature of the excess heat. In some embodiments, the heating module 27 may further include a heating unit that receives additional heat from another source.

In some embodiments, the inlet brine solution 1 includes concentrated brine produced by a preliminary separation process 201. In some embodiments, the preliminary separation process 201 may not require heating. In some embodiments, the preliminary separation process 201 may include a reverse osmosis module. In some embodiments, the preliminary separation process 201 may include an electrodialysis module. In some embodiments, other pre-treatment and/or one or more filters may be used to pre-clean the inlet brine solution 1. In some embodiments, the inlet brine solution 1 may be brackish water or brine with a lower salt concentration. In some embodiments, the inlet brine solution 1 may have a concentration of about 180,000 ppm TDS or less, about 150,000 ppm TDS or less, about 130,000 ppm TDS or less, about 100,000 ppm TDS or less, about 50,000 ppm TDS or less, or about 10,000 ppm TDS or less. In some embodiments, the inlet brine solution 1 may have a concentration of about 180,000 ppm TDS to about 10,000 ppm TDS, about 150,000 ppm TDS to about 10,000 ppm TDS, about 130,000 ppm TDS to about 10,000 ppm TDS, or about 100,000 ppm TDS to about 10,000 ppm TDS.

In some embodiments, the first separation process 2 may include membrane distillation, forward osmosis desalination, enhanced-multi effect thermal separation, or humidification-dehumidification. In some embodiments, the first separation module 20 may include one or more first separation units. For example, the first separation module 20 may include an array of membrane distillation units. In some embodiments, the second separation process 5 may include evaporation, distillation, or crystallization. In some embodiments, the second separation module 50 may include a falling film evaporator or a multi-stage flash distillation unit.

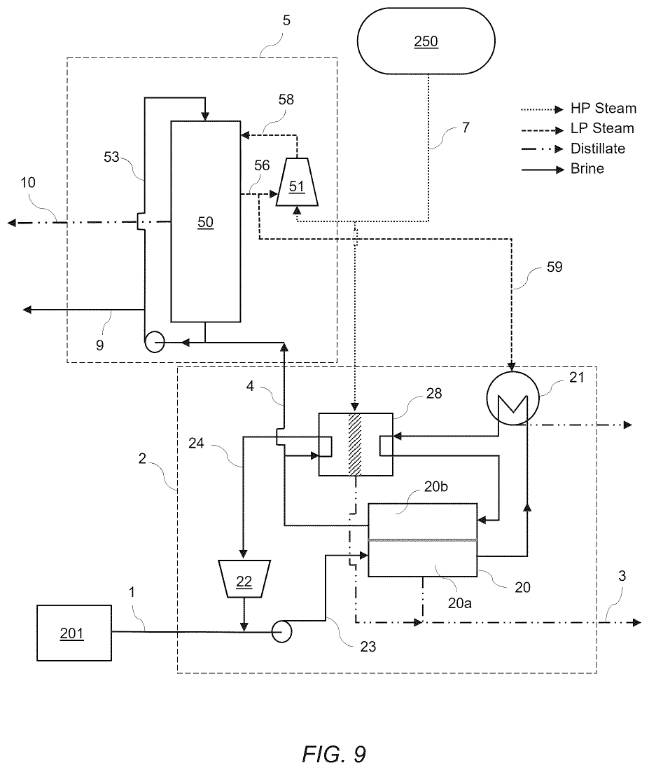

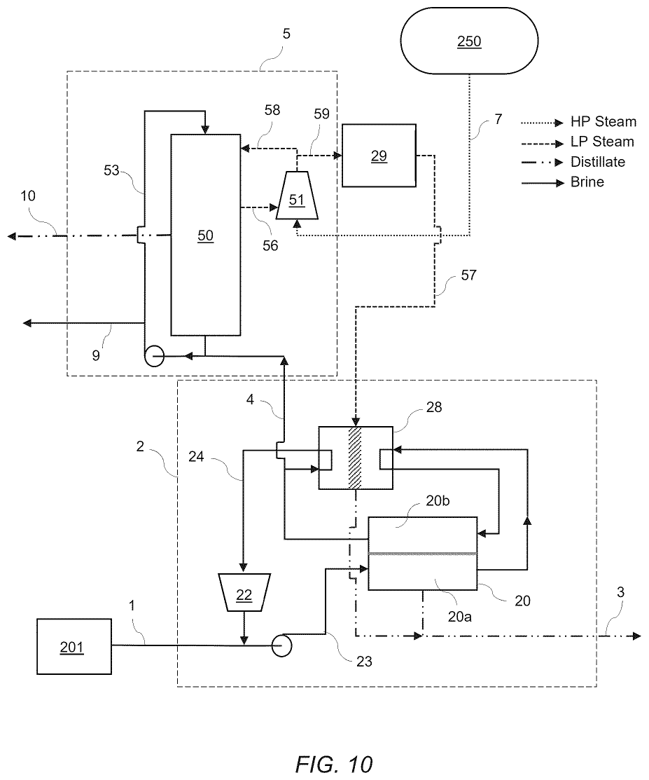

In some embodiments, as shown in FIGS. 9 and 10, the first separation process 2 includes a membrane distillation process, using a membrane distillation module (as a first separation module 20) to separate a first water distillate 3 from the inlet brine solution 1. The remaining brine solution stream becomes more concentrated, and a portion of the more concentrated brine that exits the membrane distillation module 20 (i.e., rejected brine 24) is cooled and returned to mix with additional inlet brine solution 1 to form a first circulating brine stream 23. The remaining portion of the more concentrated brine exiting the membrane distillation module is the first concentrated brine 4 and is delivered to the second separation process 5 for further water separation.

The membrane distillation module may include one or more membrane distillation units, and each membrane distillation unit has a cold side 20a and a hot side 20b separated by a porous hydrophobic membrane. The porous hydrophobic membrane is configured to separate the water from the first concentrated brine solution. In some embodiments, as shown in FIGS. 9 and 10, the inlet brine solution 1 is first circulated through the cold side 20a of the membrane distillation module 20 as a cooling medium for the cold side. The inlet brine solution 1 exits the cold side 20a and is heated by a heating module 27 to form a heated first circulating brine solution. The heated first circulating brine solution is then supplied to the hot side 20b of the membrane distillation unit. The temperature difference between the hot side 20b and the cold side 20a of a membrane distillation unit creates a vapor pressure gradient, which drives the water vapor from the first circulating brine stream 23 through the membrane from the hot side 20b to the cold side 20a, condensing as first water distillate 3. The first water distillate 3 is released as a component of a purified water stream. The first separation process produces a first concentrated brine solution 1 as retentate, which first concentrated brine solution 1 is further processed in the second stage process.

With reference to FIG. 9, in some embodiments, the heating module 27 includes a condenser 21 configured to receive excess vapor stream 59 from the second separation process to heat the first circulating brine stream 23 (or the inlet brine solution 1). In some embodiments, the heating module 27 further includes an absorption heat pump 28 configured to further heat the first circulating brine 23/inlet brine solution 1 before entering the first separation module 20. In some embodiments, the heat supplied to the absorption heat pump 28 comes from a portion of the high temperature heat 7 (e.g., from motive steam). In some embodiments, the rejected brine 24 may be circulated through the absorption heat pump 28 for heat recovery before further cooling in the cooling tower 22.

With reference to FIG. 10, in some embodiments, the first circulating brine stream 23/inlet brine solution 1 is only heated in an absorption heat pump 28 before entering the first separation module 20. In some embodiments, the absorption heat pump 28 is configured to receive excess vapor stream 59 from the second separation module 50. In some embodiments, the reduced-temperature vapor 56 from the evaporation module may be compressed by the thermocompressor 51 to form a hot vapor 55, then a portion of the hot vapor 55 is provided to the first separation process as the excess vapor stream 59 to heat the inlet solution. In some embodiments, an additional heating unit 29, such as a high temperature heat pump, may be used to further increase the temperature of the excess vapor stream 59 from the second separation module 50, thereby forming an upgraded excess vapor stream 57. The upgraded excess vapor stream 57 is supplied to the absorption heat pump 28 to allow the absorption heat pump to heat the first circulating brine stream 23 from a lower temperature to the operational temperature for membrane distillation process. In some embodiments, the high temperature heat pump 29 may be electrically powered. In some embodiments, the rejected brine 24 may be circulated through the absorption heat pump 28 for heat recovery before further cooling in the cooling tower 22. The recovered heat from the rejected brine can be used to supply heat to the absorption heat pump to heat the circulating brine stream.

The second separation process 5 further concentrates the first concentrated brine solution 4 by thermal separation. In some embodiments, the first concentrated brine solution 4 is fed to an evaporator 50 and separated into a second water distillate 10 (i.e., a condensate) and a second concentrated brine solution 9. Optionally, a portion of the second water distillate 10 may be supplied to a steam accumulator or unfired steam generator in the motive steam source 250 as feedwater. Thermal energy for the evaporator is provided by high temperature heat 7 in the form of a motive steam, which is used to drive the thermocompressor 51 to compress the reduced-temperature vapor 56 from the condenser for reuse.

The disclosed systems and processes include a thermal treatment train that can handle high-concentration brine that may still contain significant quantity of viable water and potential mineral side streams, but has traditionally been discarded as waste. The high-concentration brine may include rejected brine from a conventional water recovery from brackish sources via reverse osmosis (RO) process. Through the inclusion of a hybrid thermal desalination process, the system can recover an additional 89% of the water present in a RO reject stream while reducing the residual brine volume to less than 4% of the original feed volume, with evaporative losses accounting for the difference. Carbon emissions associated with the process depend on the source of energy used to supply electrical and thermal inputs and may be reduced or substantially avoided when low-carbon or renewable energy sources are employed.

In some embodiments a front-end reverse osmosis system performs an initial concentration of an inlet brine from approximately 5,000 ppm TDS to about 10,000 ppm TDS or greater. The resulting concentrated brine is subsequently processed by a hybrid thermal desalination process, in which a low-cost membrane distillation (MD) stage serves as a thermal bottoming process to further concentrates the brine to approximately 42,000 ppm TDS. Finally, the brine is concentrated to near saturation (~250,000 ppm TDS) in a falling-film evaporation stage capable of operating with high-salinity brines. In some embodiments, disclosed system may be able to handle the inlet solution with a concentration of as low as about 10,000 ppm TDS. In some embodiments, the inlet solution concentration may be between about 180,000 ppm TDS and about 10,000 ppm, about 130,000 ppm TDS and about 10,000 ppm TDS, about 100,000 ppm TDS and about 10,000 ppm, or about 80,000 ppm TDS and about 10,000 ppm TDS.

In some configurations, such as the embodiment illustrated in FIG. 9, thermal energy is supplied as a high temperature heat 7, such as a steam stream from a motive steam source 250 as the input to both a thermocompressor (TVC) 51 which provides the driving energy input to the evaporator process, as well as to an absorption heat pump (AHP) which provides additional heat recovery to the membrane distillation (MD) module by transferring heat from an outgoing MD stream to an incoming MD feed stream. In this configuration, the thermal energy supplied to the separation train is derived primarily from the motive steam source 250, which could be solar generated. An absorption heat pump, and a condenser for the reduced-temperature vapor from the evaporate, use a small amount of high temperature steam (such as motive steam) as driving input to allow pumping of heat from the MD cooling stream back to the MD feed stream, valorizing energy that would otherwise be rejected in the cooling tower to allow expansion of the MD process. As a result, the MD capacity may be increased while maintaining a Gain Output Ratio (GOR) comparable to that of the overall hybrid system, for example on the order of about 4.7. As used herein, the gain output ratio (GOR) is defined as the ratio of distillate mass flow to high temperature steam mass flow under steady-state operation.

For brine feed streams having salinity below approximately 130,000 ppm, the use of a heat pump, such as absorption heat pump 28, enables a greater fraction of water recovery to be achieved in the first separation process relative to water recovery in the second separation process. This configuration is advantageous when the first separation process has a lower capital cost per unit of recovered water than the second separation process, such as when the first separation process comprises membrane distillation and the second separation process comprises a falling film evaporator.

In other configurations, such as the embodiment illustrated in FIG. 10, high temperature steam 7 is supplied only to the evaporator 50 via a thermocompressor 51, then taking the hot vapor from the evaporator process and passing it through a high-temperature heat pump (HTHP) to updated to a higher temperature for driving the AHP, thereby reducing the overall consumption of the high temperature steam 7.

Although both ‘thermal dominant’ and ‘hybrid thermal-electric’ configurations described above provide comparable water recovery and output water quality, they differ in the balance of thermal and electric energy consumption and associated equipment costs. In the ‘hybrid thermal-electric’ configurations, the absorption heat pump is driven by upgraded excess vapor stream 57 upgraded by the high temperature heat pump, rather than driven by high temperature heat 7. By upgrading evaporator vapor from approximately 100° C. to approximately 180° C., the high temperature heat pump enables the absorption heat pump to supply increased heat input to the MD process, allowing a greater fraction of water recover to be achieved by the MD process. In some embodiments, the hybrid thermal-electric configurations may provide more than twice the amount of heat input for the MD process, allowing for a doubling of the MD process fraction compared to other high salinity processes. In some embodiments, the hybrid thermal-electric configurations eliminate the need for a condenser for excess evaporator vapor and reduce overall thermal demand for the process by 35%, allowing for reduced CAPEX on the solar and plant equipment in exchange for increased electrical power consumption.

In high salinity applications, feed streams supplied to thermal desalination systems may have salinities on the order of about 180,000 ppm TDS, whereas brackish water application typically involve salinities on the order of 10,000 ppm TDS. At lower salinities, a greater fraction of water recovery may be achieved using MD. However, for conventional high salinity thermal processes, the thermal coupling can limit the ability to simply expand the bottoming process, as the heat input available is tied to the excess heat produced from the evaporator. Directly applying high temperature steam 7, such as solar steam, for additional MD heat input is inefficient, as the temperature of the high temperature heat 7 substantially exceeds what is needed for MD heat input. The present disclosure provides processes and systems that decouple heat generation from heat utilization, which enables efficient thermal exchange and expansion of MD capacity without the drawbacks of prior approaches.

Systems implementing the processes disclosed herein can achieve overall water recovery on the order of 95% from an initial well intake (prior to any front-end separation process) to the final saturated brine discharge from the evaporator. This represents a substantial increase relative to the approximately 50-60% recovery common for RO systems operating with similar feedwater. In some embodiments, the systems and processes disclosed herein produce drinking-grade water with a TDS of approximately 500 ppm or less and substantially free of organic compounds, ammonia, and hazardous metals.

In thermal-dominant configurations, the systems may exhibit specific thermal energy consumption of approximately 130-150 kWhₜₕ per cubic meter of water produced and a specific electrical performance of 12-20 kWhₑ per cubic meter of water produced. In hybrid thermal-electric configurations, the systems may exhibit reduced specific thermal energy consumption of approximately 85-95 kWhₜₕ per cubic meter of water produced and specific electric energy consumption of approximately 25-31 kWhₑ per cubic meter of water produced.

Various embodiments have been described above. Although the systems and processes has been described with reference to these specific embodiments, the descriptions are intended to be illustrative and are not intended to be limiting. Various modifications and applications may occur to those skilled in the art without departing from the true spirit and scope of the systems and processes as defined in the appended claims.

### EXAMPLES

### Example 1

As shown in FIG. 3, a solar thermal collector or array of collectors 60 delivering heat to a circulating working fluid 61 which may be liquid, gaseous, or mixed phases in some embodiments. The working fluid is delivered to a unit process for producing saturated steam or extracting thermal energy from the fluid 62 which may be a steam generator, heat exchanger, or vapor liquid separator in various embodiments. Saturated steam 63 is delivered to a steam accumulator or thermal storage device capable of producing steam 64. Saturated solar steam 7 is provided at pressures of 50-100 psig as the primary energy input to the second separation process 5, acting as the motive fluid for a thermocompressor 51. Superheated steam 54 is produced from the thermocompressor at a pressure, P14, which corresponds to a saturation temperature that exceeds the temperature T1 of circulating brine 53 within the evaporator 60. The superheated steam 54 is brought back to a saturated state at pressure P14 by means of a de-superheater 52. The resulting saturated steam 55 enters the evaporator 60 where it condenses on the exterior of vertical tubes, providing heat for the liberation of water vapor 8 from the recirculating brine 53. The pure water condensate 10 exits the evaporator 60 and joins the other condensate streams at the condenser 21. A stream of saturated brine 9 is continuously withdrawn from the evaporator for disposal in an evaporation pond at saturated concentrations of 25-30% TDS by weight.

The first separation process 2 is provided with process heat from the condensation of excess vapor 8 produced in the evaporator within the condenser 21. The condenser heats brine up to temperatures T2 appropriate for operating the hot-side of a thermal membrane distillation MD or forward osmosis FO process 20. The permeate from the membrane process 30 is connected to the condenser 21 which, in some embodiments, may provide vacuum pressures to encourage enhanced performance from the membrane process. The reject brine leaving the membrane process 24 passes through a cooling process 22 and is mixed with the incoming brine stream 1 before re-entering the membrane process 20 and providing the low temperatures needed for operation. After the membrane process 20 the moderate temperature brine stream 1 provides the cooling needed to condense vapor supplied to the condenser. All of the condensed distillate 3 is delivered to a distillate tank 11 where it is withdrawn for use as needed including in some embodiments the liquid feedwater for the solar steam generation or for the de-superheater 52.

Using the MD process, we are able to achieve the desired volume reduction (only 10% of the feed brine at 3% TDS is rejected as concentrated brine) with a corresponding recovery of at least 83% and a GOR of greater than 6.

### Example 2

As shown in FIG. 4, a modified version of the process with all changes related to the first separation process 2, while the other units remain as described for FIG. 3. In this embodiment, the first brine stream 23 and incoming brine 1 only pass through the hot side of the membrane process 20 after receiving heat from the condenser 21. The cold side of the membrane process 20 is maintained by the use of a stream of distillate 25 which was passed through the cooling process 22 from the distillate tank 11. After exiting the membrane process 8, the warm distillate 26 joins the other distillate streams at the condenser 22. This configuration allows for the use of standard inexpensive metallurgical materials for the cooling process 9 which is no longer handling brine but only distillate.

### Example 3

As shown in FIG. 5, a modified version of the process with all changes related to the second separation process 5 while other units remain as described for FIG. 3. Specifically, the brine stream leaving the evaporator 9 is no longer delivered to an evaporation pond, but is instead delivered to a forced convection crystallizer (FCC) 140 for final separation of water and solids. In this configuration, the brine leaving the evaporator 9 may not be at a saturated concentration, but an intermediate concentration in the range of 10-20% wt TDS. Within the crystallizer 140 a portion of the vapor released from the brine 33 is compressed within a thermocompressor 143 driven by solar steam 7 to a superheated state, and then brought back to saturation by a desuperheater 144 resulting in saturated steam 146 at a pressure P34 whose corresponding saturation temperature exceeds the crystallizer temperature T3. The condensation of this steam 146 in a shell and tube heat exchanger 141 provides the heat needed for liberation of vapor within the crystallizer 140 as well as a stream of condensate that returns to the condensate tank 11. Brine within the crystallizer is maintained at or above saturation concentrations of 25-30% wt TDS to allow the formation of solids which are removed from a flow of brine 147 which passes through a filtration process 142 on its way to the condensing heat exchanger 141 before returning to the crystallizer. The filtrate waste stream 12 which may consist of solids, a slurry, or a saturated solution in various embodiments is then disposed of outside of the process. The excess portion of the liberated vapors 145 are passed to the condenser 21 to provide additional heat input to the second stage water removal process.

### Example 4

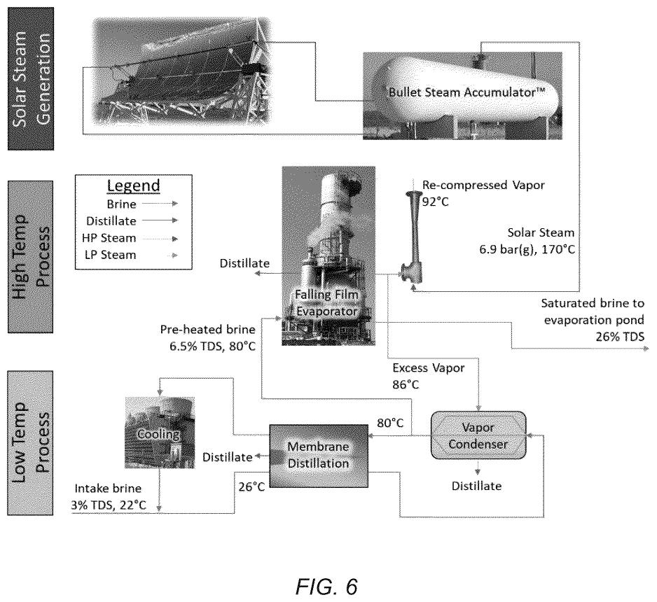

The hybrid process described herein can overcome the disadvantages of conventional high recovery processes like MVR or limitations of solar thermal implementations utilizing TVR. As illustrated in FIG. 6, the exemplified hybrid process combine solar steam generation utilizing solar collector and steam accumulator, a high temperature process with falling film evaporator (FFE), and a low temperature process with thermal membrane distillation (MD).

The key components of the desalination side of the scalable exemplified hybrid process were priced for the 5 MW-scale commercial facility with estimated installed costs. The installed capital costs for equipment were utilized along with the levelized cost of heat (LCOH) for solar thermal process heat to develop final estimates of levelized cost of water (LCOW) for the exemplified hybrid process as well as for two reference cases: (1) a solar thermal vapor recompression system sized for the same overall solar thermal input power, and (2) a MVR system sized to match the nominal saturated brine rejection rate of the hybrid system, at ~835 m³/day of saturated brine. The results are shown in Table 1.

TABLE 1
Desalination Process LCOW Determination

| | SCEPTRE | Solar TVR | | |
|---|---|---|---|---|
| | SM = 3 | SM = 3 | MVR | |
| | CUF = 62% | CUF = 62% | CUF = 95% | |
| Yield | | | | |
| GOR | 6.2 | 2.9 | N/A | |
| Permeate yield | 310,192 | 138,364 | 289,536 | m³/yr |
| Daily avg permeate flow | 850 | 379 | 793 | m³/day |
| LCOW (heat is part of OPEX) | | | | |
| Desalination CAPEX | $11,972,332 | $7,458,298 | $9,964,267 | |
| OPEX (heat for desal) | $852,778 | $852,778 | N/A | $/yr |
| OPEX (electricity for desal) | $28,476 | $23,323 | $1,100,238 | $/yr |
| OPEX (other desal) | $332,873 | $290,288 | $488,660 | $/yr |
| Total OPEX | $1,214,127 | $1,166,389 | $1,588,898 | $/yr |
| LCOW | $7.04 | $12.78 | $8.26 | $/m³ |

The exemplified hybrid process provides a significant (114%) increase in the GOR of the overall desalination process, boosting yield for the same solar steam consumption rate over the existing solar TVR process. The MVR capital expenditure (CAPEX) exceeds that of the hybrid process due to the presence of the compressor and the larger size of the capital-intensive FFE system needed to match the nominal concentrate output rate of the hybrid process, which benefits from the presence of the low-cost MD components to handle the initial brine concentrating at lower temperatures. Both of the solar processes use the same amount of heat as the primary annual operating expenditure (OPEX) input, and only small amounts of electricity for pumping, for a total energy-consumption OPEX of less than $883,000, while the MVR process requires $1,100,000 in grid electricity. Other OPEX for the hybrid process includes replacement membranes on a 4-year replacement schedule as well as other MD service, chemical use, and labor. The MVR process, with its larger FFE system and higher capacity factor, requires proportionally more service and maintenance expenses. The MVR pump is known to require high service and maintenance costs.

The resulting values of LCOW show clearly that utilizing the excess heat from the topping TVR system with MD provides a 45% reduction in LCOW compared to solar thermal desalination via topping-only TVR, to a level of $7.04/m³, representing not only a significant improvement for solar desalination, but also reaching commercial relevance by falling below the current state-of-the-art MVR LCOW of $8.3/m³.

What is claimed is:

1. A system for concentrating a solution, comprising:
a first separation module configured to separate water from an inlet solution stream to form a first concentrated solution and a first water stream;
a second separation module configured to further separate water from the first concentrated solution to form a second concentrated solution and a second water stream; wherein a high temperature steam provides heat to the second separation module;
a heating module comprising a first heating unit configured to utilize excess heat from the second separation module to heat an inlet solution before entering the first separation module for water separation; and
a liquid conduit connecting the first separation module and the second separation module and is configured to deliver at least a portion of the first concentrated solution to the second separation module.

2. The system of claim 1, wherein the first separation module comprises one or more of a membrane distillation module, a forward osmosis desalination module, an enhanced-multi effect thermal separation module, and a humidification-dehumidification module.

3. The system of claim 1, wherein the second separation module comprises an evaporator.

4. The system of claim 3, wherein the second separation module further comprises a thermocompressor configured to recycle a reduced-temperature vapor exiting the evaporator, wherein the thermocompressor is driven by the high temperature steam.

5. The system of claim 1, wherein the heating module further comprises a second heating unit downstream of the first heating unit, wherein the second heating unit is configured to utilize a portion of the high temperature steam to further heat the inlet solution.

6. The system of claim 5, wherein the second heating unit is an absorption heat pump.

7. The system of claim 6, wherein the first heating unit is a condenser.

8. The system of claim 1, wherein the first heating unit comprises an absorption heat pump.

9. The system of claim 8, further comprising a high temperature heat pump configured to heat an excess vapor stream from the second separation module prior to being used by the absorption heat pump to heat the inlet solution.

10. The system of claim 1, therein the inlet solution comprises a brine having a concentration of about 10,000 ppm TDS and higher.

11. The system of claim 1, further comprising an upstream reverse osmosis module that produces the inlet solution.

12. A process for concentrating an inlet solution, comprising:
heating an inlet solution to form a heated inlet solution;
feeding the heated inlet solution into a first separation process thereby producing a first concentrated solution and a first water stream; and
feeding the first concentrated solution into a second separation process thereby producing a second concentrated solution and a second water stream;
wherein the second separation process is configured to use a high temperature steam as an energy source, and an excess heat from the second separation process is delivered to the first separation process for heating the inlet solution.

13. The process of claim 12, wherein heating the inlet solution comprises feeding the inlet solution through a condenser heated by the excess heat.

14. The process of claim 13, wherein heating the inlet solution further comprises feeding the inlet solution through an absorption heat pump after feeding through the condenser, wherein the absorption heat pump receives heat from a portion of the high temperature steam.

15. The process of claim 12, wherein heating the inlet solution comprises feeding the inlet solution through an absorption heat pump configured to receive heat from the excess heat.

16. The process of claim 15, wherein the excess heat comprises upgraded excess vapor stream produced by feeding an excess vapor stream from the second separation process through a high temperature heat pump.

17. The process of claim 13, wherein the first separation process comprises membrane distillation.

18. The process of claim 13 Wonder I, wherein the second separation process comprises evaporation.

19. The process of claim 18, wherein the high temperature steam is used as a motive steam to drive a thermocompressor to recover a reduced-temperature vapor from the second separation process.
